(19) United States
(12) Patent Application Publication
(10) Pub. No.: US 2016/0048503 A1
(43) Pub. Date: Feb. 18, 2016

(54) SPEECH ASSISTANCE SYSTEM IN COMBINATION WITH MOBILE DEVICE

(71) Applicant: RICHPLAY INFORMATION CO., LTD., NEW TAIPEI CITY (TW)

(72) Inventors: CHI-HSIN LIANG, NEW TAIPEI CITY (TW); JUN-HUI WU, NEW TAIPEI CITY (TW); YI-HAO HUANG, NEW TAIPEI CITY (TW); YI-HSIANG CHEN, NEW TAIPEI CITY (TW)

(21) Appl. No.: 14/821,944

(22) Filed: Aug. 10, 2015

(30) Foreign Application Priority Data
Aug. 18, 2014 (TW) 103128359

(51) Int. Cl. G06F 17/28; G10L 15/26

(52) U.S. Cl. CPC G06F 17/28; G10L 15/26

(57) ABSTRACT

A speech assistance system in combination with at least one mobile device is revealed. While a speaker is delivering a speech. a speech assistant image is shown on a display under control of a control device. At the same time, the speech is received and delivered to the control device by a voice receiving device in a real-time manner. After the control device receiving the speech, the speech is immediately converted to a first speech text by a speech recognition module. Then a translation module translates the first speech text into a first translated text of the speech. An audience uses a mobile device to show the first speech text or play the speech of the first translated text to have a better understanding of content of the speech.

### FIELD OF THE INVENTION

The present invention relates to a speech assistance system in combination with at least one mobile device, especially to a speech assistance system which receives a speech of a speaker, recognizes the speech and translates the speech into a translated text into different languages. Then an audience gets the translated text in the indicated language through a mobile device and has a better understanding of the content of the speech.

### BACKGROUND OF THE INVENTION

Over the last hundred years, development of transportation and information technology has changed our lifestyle significantly. People, materials and good are moved quickly and globally due to progress in transportation. With the Internet as the representative of information technology, information and knowledge have been replicated and propagated rapidly across borders. At the same time, large capital flows over a short period. The geographical boundaries have become blurred and undefined and the distance between people has been compressed. People start to takes the whole world as one body. The global awareness such as the earth is flat and the like has been raised. The concept of global village has been popularized. The globe has been contracted into a village and people are as close as likely in a village.

The term globalization has been increasingly used by people since the 1980s and also has become one of the hot research topics. The globalization has affected various fields including economics, politics, culture, etc. The cross-border flow and trade of tangible goods and intangible services make best allocation and efficient utilization of various factors/resources of production over the world. The increasing economic integration and interdependence of national economies across the world further have influence on politics.

The propagation of information is much faster than people and goods due to internet. The knowledge and concepts have been shared globally and become important assets. However, a gap caused by difference in languages among various countries and species will impede information exchange. For example, people can find speech videos given by scholars or officials of other countries. Or people may attend seminars in other countries and listen to the speech given by foreigners. Whether an audience is familiar with the language the speaker uses will affect his understanding of content of the speech.

In order to solve the problems mentioned above, a speech assistance system in combination with at least one mobile device is provided by the present invention. During the speech, the speaker can control a display device by a control device to show a speech assistant image. At the same time, the speech is received and delivered to the control device by a voice receiving device instantly. Then a speech recognition module converts the speech into a first speech text immediately. Next a translation module translates the first speech text into a first translated text of the speech. An audience uses a mobile device to connect to the control device, show the first speech text or play the speech of the first translated text. Thus can understand content of the speech more efficiently.

### SUMMARY

Therefore it is a primary object of the present invention to provide a speech assistance system in combination with at least one mobile device, which receives a speech of a speaker, recognizes the speech and translates the speech into a translated text in different languages. Then an audience gets the translated text in the indicated language through a mobile device. Thus an instant and customized speech translation service is provided to the audience and the audience can understand content of the speech more efficiently.

It is another object of the present invention to provide a speech assistance system in combination with at least one mobile device, which recognizes and translates words in a speech assistant image instantly into a translated text in different languages. Then an audience gets the translated text in the indicated language through a mobile device. Thus an instant and customized speech-to-text translation service is provided to the audience and the audience can understand content of the speech more efficiently.

It is a further object of the present invention to provide a speech assistance system in combination with at least one mobile device, which takes images of a speech of a speaker, instantly recognizes words in the image of the speech and translates the words into a translated text in different languages. Then an audience gets the translated text in the indicated language through a mobile device. The present invention provides the audience an instant and customized speech-to-text translation service and the audience can understand content of the speech more efficiently.

It is a further object of the present invention to provide a speech assistance system in combination with at least one mobile device, in which an audience gets an electronic questionnaire, fills the electronic questionnaire out and returns the filled electronic questionnaire back through a mobile device. Then the responses to the electronic questionnaire are analyzed and statistical results are displayed. Thus the speaker can get audience feedback. The speaker and the audience can exchange their opinions.

In order to achieve the above objects, a speech assistance system in combination with at least one mobile device of the present invention includes a voice receiving device, a control device, a display device and at least one mobile device. The voice receiving device, the display device and the mobile device are connected to the control device respectively. The control device consists of a speech recognition module and a translation module electrically connected to the speech recognition module.

When a speaker is delivering a speech, a speech assistant image is shown on the display device under control of the control device. The speech is received and sent to the control device by the voice receiving device instantly. After the control device receiving the speech, the speech recognition module converts the speech into a first speech text in a real-time manner. The translation module translates the first speech text into a first translated text of the speech. An audience can get the first translated text of the speech by a mobile application program installed in the mobile device. The first translated text of the speech is shown on the mobile device or the speech of the first translated text is played by the mobile device.

A speech assistance system in combination with at least one mobile device according to the present invention is composed of a voice receiving device, a control device, a display device and a mobile device. The voice receiving device, the display device and the mobile device are connected to the control device respectively. The control device includes a speech recognition module while a mobile application program installed in the mobile device includes a translation module.

While the speaker is giving a speech, a speech assistant image is shown on the display device under control of the control device. The voice receiving device instantly receives the speech and delivers the speech to the control device. After the control device receiving the speech, the speech is converted to a first speech text by the speech recognition module. An audience can get the first speech text by a mobile application program installed in the mobile device and the first speech text is translated into a first translated text of the speech by the translation module. The first translated text of the speech is shown on the mobile device or the speech of first translated text is played by the mobile device.

A speech assistance system in combination with at least one mobile device according to the present invention consists of a voice receiving device, a control device, a display device and a mobile device. The voice receiving device, the display device and the mobile device are connected to the control device respectively. A mobile application program installed in the mobile device includes a speech recognition module and a translation module.

While giving a speech, a speaker uses the control device to show a speech assistant image on the display device. The speech is received and sent to the control device instantly by the voice receiving device. An audience can get the speech by a mobile application program installed in the mobile device. The speech is instantly converted into a first speech text by the speech recognition module while the translation module translates the first speech text into a first translated text of the speech. The first translated text of the speech is shown on the mobile device or the speech of the first translated text is played by the mobile device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing component connection of an embodiment according to the present invention;

FIG. 2 is a block diagram showing component connection of an embodiment according to the present invention;

FIG. 3 is a block diagram showing component connection of another embodiment according to the present invention;

FIG. 4 is a block diagram showing component connection of a further embodiment according to the present invention.

### DETAILED DESCRIPTION

In order to understand technical features and effects of the present invention, please refer to the following detailed description of embodiments.

A speech assistance system in combination with at least one mobile device according to the present invention features on that the speech of the speaker is received, recognized and translated into translated text in different languages. The audience gets the translated text of the speech in the language he requires through a mobile application program of a mobile device. Moreover, the present invention can also translate words indicated or written in a speech assistant image of the speaker, analyze responses to the questionnaire of the audience and show a statistical result of the electronic questionnaire. Thus the audience has a better understanding of content of the speech. The speaker and the audience can exchange their opinions.

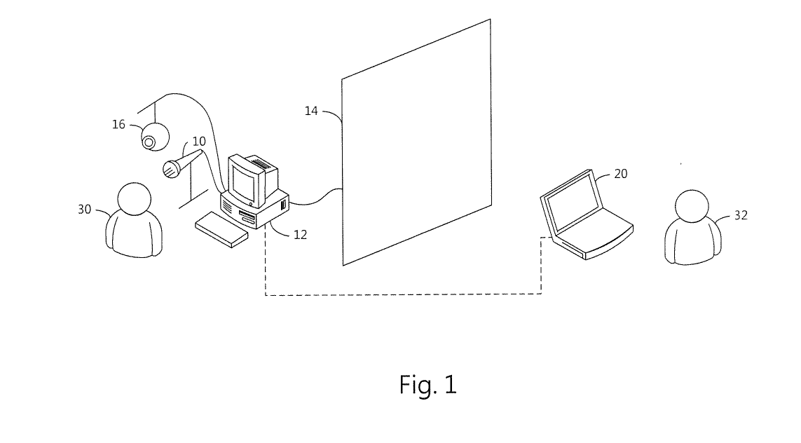

Refer to FIG. 1, a speech assistance system combined with at least one mobile device of the present invention includes a voice receiving device 10, a control device 12, a display device 14 and at least one mobile device 20. The voice receiving device 10, the display device 14 and the mobile device 20 are connected to the control device 12 respectively.

While giving a speech, a speaker 30 operates the control device 12 to show a speech assistant image 140 on the display device 14. The speech is received and delivered to the control device 12 by the voice receiving device 10. An audience 32 is connected to the control device 12 through the mobile device 20.

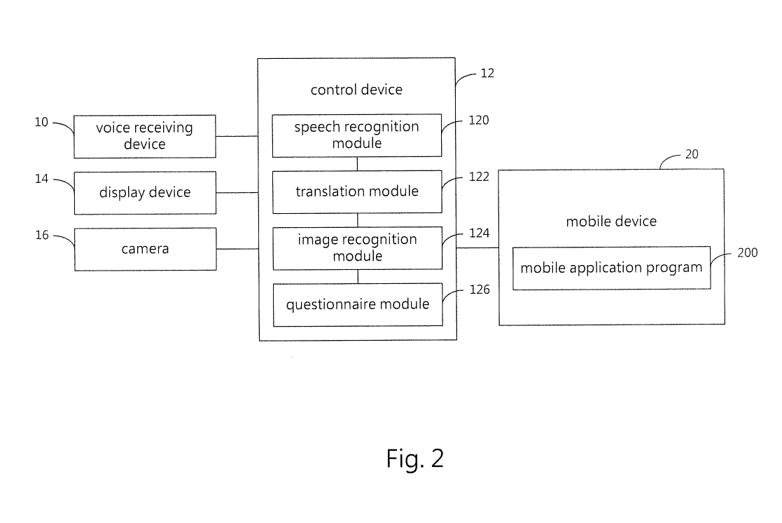

Refer to FIG. 1 and FIG. 2, the control device 12 consists of a speech recognition module 120 and a translation module 122 electrically connected to the speech recognition module 120. After the speech being received and delivered to the control device 12 by the voice receiving device 10, firstly the speech recognition module 120 converts the speech into a first speech text. Then the translation module 122 translates the first speech text into a first translated text of the speech. The mobile device 20 gets the first translated text of the speech from the control device 12 through a mobile application program 200 and then shows the first speech text of the speech or play a speech of the first translated text. Thus the audience 32 can understand the speech content of the speaker 30 more easily.

According to the arrangement of the components mentioned above, the speech assistance system in combination with at least one mobile device of the present invention recognizes the speech of the speaker in a real-time manner to generate the first speech text. Then the first speech text is translated into the first translated text of the speech instantly. The first translated text of the speech is displayed on or played by the mobile application program of the mobile device so as improve the efficiency of the audience to understand the content of the speech.

Moreover, the speaker 30 can set an indicated range within the speech assistant image 140 by the control device 12 to remind the audience 32 key points in the speech assistant image 140. A second speech text is generated by the control device 12 instantly according to words within the indicated range. In this embodiment, the translation module 122 included in the control device 12 translates the second speech text into a second translated text of the speech instantly. Then the second translated text of the speech is shown on the mobile device 20 or a speech of the second translated text is played by the mobile device 20.

According to the arrangement of the components mentioned above, the speech assistance system in combination with at least one mobile device of the present invention recognizes the indicated words in the speech assistant image 140 to generate the second speech text in a real-time manner during the speech of the speaker 30. Then the second speech text is translated into the second translated text of the speech instantly. The second translated text of the speech is shown on or played by the mobile application program of the mobile device. By the second translated text in combination with the first translated text of the speech, the efficiency of the audience to understand the content of the speech is improved.

Still refer to FIG. 1 and FIG. 2, the speech assistance system in combination with at least one mobile device of the present invention further includes a camera 16 and the control device 12 further includes an image recognition module 124. The camera 16 connected to the control device 12 is used for taking an image of the speech 160 and sending the image of the speech 160 to the control device 12. After the control device 12 getting the image of the speech 160, the image recognition module 124 recognizes words in the image of the speech 160 in a real-time manner (either words contained in the speech assistant image speech 140 or words written by the speaker 30) to generate a third speech text. In this embodiment, the translation module 122 of the control device 12 translates the third speech text into a third translated text of the speech in a real-time manner and the mobile device 20 gets the third translated text of the speech from the control device 12 through the mobile application program 200. Then the third translated text of the speech is shown on the mobile device 20 or the speech of the third translated text is played by the mobile device 20.

According to the arrangement of the components mentioned above, the speech assistance system in combination with at least one mobile device of the present invention uses either words contained in the speech assistant image or words written by the speaker as a third speech text. Then the third speech text is translated into a third translated text of the speech in a real-time manner. The third translated text of the speech is shown on or played by the mobile application program of the mobile device. By the third translated text in combination with the first translated text or the second translated text of the speech, the audience has a better understanding of the content of the speech with the assistance of the system.

Refer to FIG. 2, the control device 12 further includes a questionnaire module 126 stored with an electronic questionnaire therein. The speaker 30 can ask the audience 32 to get the electronic questionnaire from the questionnaire module 126 of the control device 12 through the mobile application program 200 of the mobile device 20. The mobile device 20 is used for connecting the audience 32 to the control device 12. Then the audience 32 fills the electronic questionnaire out and returns the filled questionnaire back to the questionnaire module 126. The questionnaire module 126 collects responses to the questionnaire and shows a statistical result of the electronic questionnaire on the display device 14.

According to the arrangement of the components mentioned above, the electronic questionnaire of the speech assistance system in combination with at least one mobile device according to the present invention is used to conduct a questionnaire survey. Thus the speaker can collect the audience's opinions, allowing more interactions between the speaker and the audience.

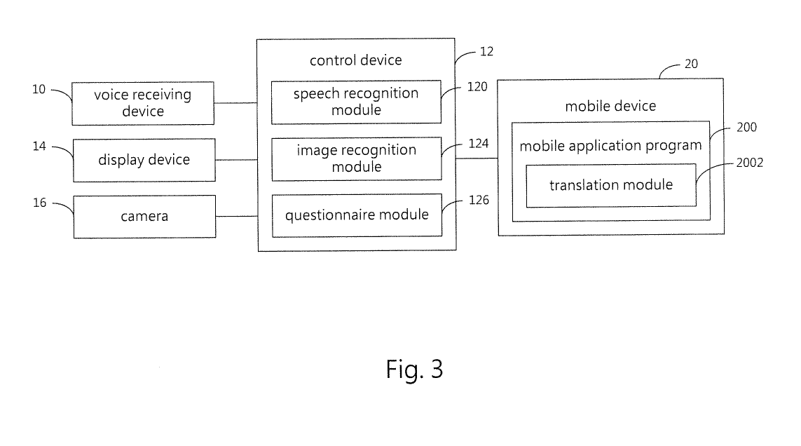

Refer to FIG. 1 and FIG. 3, the control device 12 further includes a speech recognition module 120 while the mobile application program 200 of the mobile device 20 includes a translation module 2002. The speech is received and delivered to the control device 12 by the voice receiving device 10. Then the speech is converted to a first speech text by the speech recognition module 120. The mobile device 20 gets the first speech text from the control device 12 through the mobile application program 200. Next the translation module 2002 translates the first speech text into a first translated text of the speech. The first translated text of the speech is shown on the mobile device 20 or a speech of the first translated text is played by the mobile device 20. Thus the audience 32 can understand the speech of the speaker 30 more clearly with the assistance of the system.

In this embodiment, the speaker 30 can also set an indicated range in the speech assistant image 140 to remind the audience 32. A second speech text is generated instantly by the control device 12 according to words within the indicated range. The mobile device 20 gets the second speech text from the control device 12 through the mobile application program 200. Then the translation module 2002 translates the second speech text into a second translated text of the speech in a real-time manner. The second translated text of the speech is shown on the mobile device 20 or the speech of the second translated text is played by the mobile device 20.

Moreover, this embodiment of the speech assistance system in combination with at least one mobile device according to the present invention also includes a camera 16 that is connected to the control device 12. The control device 12 further includes an image recognition module 124. The camera 16 captures an image of the speech 160 and sends the image of the speech 160 to the control device 12. Then words in the image of the speech 160 are recognized by the image recognition module 124 of the control device 12 instantly to generate a third speech text. Next the mobile device 20 gets the third speech text through the mobile application program 200 and translates the third speech text into a third translated text of the speech in a real-time manner by the translation module 2002. The third translated text of the speech is shown on the mobile device 20 or the speech of the second translated text is played by the mobile device 20.

According to the arrangement of the components mentioned above, the speech assistance system in combination with at least one mobile device according to the present invention generates various speech texts according to the speech of the speaker, words within the indicated range of the speech assistant image, or words written by the speaker. Then the speech texts are translated into translated texts of the speech instantly. Next the translated texts of the speech are shown or played through the mobile application program of the mobile device for helping the audience understand more about the content of the speech.

Refer to FIG. 3, the control device 12 of this embodiment further includes a questionnaire module 126 for conducting questionnaire surveys and showing statistical results of the questionnaire.

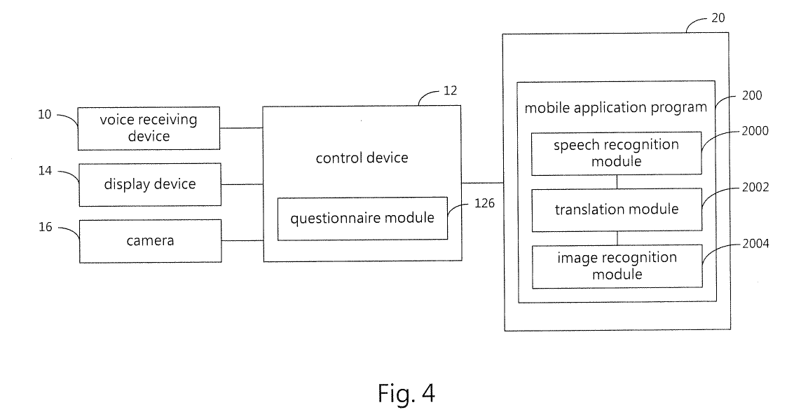

Refer to FIG. 1 and FIG. 4, a further embodiment is disclosed. As shown in figures, a mobile application program 200 of a mobile device 20 further includes a speech recognition module 2000 and a translation module 2002. The speech is received and delivered to the control device 12 by a voice receiving device 10. Then the mobile device 20 gets the speech from the control device 12 through the mobile application program 200 and converts the speech into a first speech text by the speech recognition module 2000 of the mobile application program 200. Next the first speech text is translated into a first translated text of the speech by the translation module 2002. The first translated text of the speech is shown on the mobile device 20 or the speech of the first translated text is played by the mobile device 20 an as to help the audience 32 understand more about the speech of the speaker 30.

In this embodiment, a second speech text is generated by the control device 12 according to words within the indicated range of the speech assistant image 140. The mobile device 20 gets the second speech text through the mobile application program 200 and the translation module 2002 translates the second speech text into a second translated text of the speech instantly. The second translated text of the speech is shown on the mobile device 20 or the speech of the second translated text is played by the mobile device 20 for helping the audience 32 get the points.

Moreover, this embodiment of the speech assistance system in combination with at least one mobile device according to the present invention further includes a camera 16 connected to the control device 12. The mobile application program 200 of the mobile device 20 further includes an image recognition module 2004. The camera 16 captures an image of the speech 160 and sends the image of the speech 160 to the control device 12. Then the mobile device 20 gets the image of the speech 160 through the mobile application program 200 and recognizes words in the image of the speech 160 instantly by the image recognition module 2004 so as to generate a third speech text. Next the third speech text is translated into a third translated text of the speech by the translation module 2002 of the mobile application program 200 in a real-time manner. The third translated text of the speech is shown on the mobile device 20 or the speech of the third translated text is played by the mobile device 20.

According to the arrangement of the components mentioned above, the speech assistance system in combination with at least one mobile device according to the present invention generates speech texts according to the speech of the speaker, words within the indicated range of the speech assistant image, or words written by the speaker. Then the speech texts are translated into translated texts of the speech instantly. Next the translated texts of the speech are shown on or played by the mobile device for helping the audience understand more about the content of the speech.

Refer to FIG. 4, in this embodiment, the control device 12 further includes a questionnaire module 126 for conducting questionnaire surveys and showing statistical results of the questionnaire. The questionnaire module 126 has the same function as the one of the above embodiments.

In summary, the speech assistance system in combination with at least one mobile device according to the present invention uses the voice receiving device to receive the speech given by the speaker. Then the speech is instantly converted into a first speech text by the speech recognition module in the control device/or the mobile device. The first speech text is translated to a first translated text of the speech in a real-time manner by the translation module in the control device/or the mobile device. The mobile device shows the first translated text of the speech or plays speech of the first translated text. Thus the audience has a better understanding of the content of the speech. Moreover, a second speech text or a third speech text can be generated by the control device/or the camera together with the image recognition module in the control device/or the mobile device according to the words contained in the indicated range of the speech assistant image or the words written by the speaker. Then the second/third speech text is instantly translated into a second/third translated text of the speech by the translation module in the control device/or the mobile device. Thus the audience can understand the speech of the speaker more clearly with the assistance of the system. Furthermore, the audience can get the electronic questionnaire from the questionnaire module of the control device through the mobile device, fill out the electronic questionnaire and returns the filled electronic questionnaire back. The questionnaire module collects responses to the questionnaire and gets statistical results. Thus the speaker and the audience can exchange their opinions.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A speech assistance system in combination with at least one mobile device comprising:
a voice receiving device used for instantly receiving a speech;
a control device that is connected to the voice receiving device, receiving the speech in a real-time manner, and having:
a speech recognition module that converts the speech into a first speech text instantly; and
a translation module electrically connected to the speech recognition module and used for translating the first speech text into a first translated text of the speech instantly;
a display device connected to the control device and controlled by the control device to show a speech assistant image; and
a mobile device connected to the control device and installed with a mobile application program for getting the first translated text of the speech.

2. The system as claimed in claim 1, wherein an indicated range is formed in the speech assistant image by the control device and a second speech text is generated instantly according to words in the indicated range.

3. The system as claimed in claim 2, wherein the second speech text is instantly translated to a second translated text of the speech by the translation module of the control device and the mobile application program gets the second translated text of the speech instantly.

4. The system as claimed in claim 3, wherein the second translated text of the speech is shown on the mobile device or a speech of the second translated text is played by the mobile device instantly.

5. The system as claimed in claim 1, wherein the speech assistance system further includes a camera connected to the control device; the camera is used for instantly taking an image of the speech and sending the image of the speech to the control device.

6. The system as claimed in claim 4, wherein the image of the speech includes the speech assistant image shown on the display device.

7. The system as claimed in claim 4, wherein the control device further includes an image recognition module that recognizes words in the image of the speech instantly to generate a third speech text.

8. The system as claimed in claim 6, wherein the image recognition module is electrically connected to the translation module and the third speech text is translated to a third translated text of the speech instantly by the translation module; the mobile device gets the third translated text of the speech instantly.

9. The system as claimed in claim 8, wherein the third translated text of the speech is shown on the mobile device or a speech of the third translated text is played by the mobile device instantly.

10. The system as claimed in claim 1, wherein the first translated text of the speech is shown on the mobile device or a speech of the Oct translated text is played by the mobile device instantly.

11. The system as claimed in claim 1, wherein the control device further includes a questionnaire module; an electronic questionnaire is sent from the questionnaire module of the control device to the mobile device and then a response to the electronic questionnaire is returned from the mobile device back to the control device; the questionnaire module collects the response to the electronic questionnaire and shows a statistical result of the electronic questionnaire on the display device.

12. A speech assistance system in combination with at least one mobile device comprising:
a voice receiving device used for instantly receiving a speech;
a control device that is connected to the voice receiving device, receiving the speech in a real-time manner, and having a speech recognition module that converts the speech into a first speech text instantly;
a display device connected to the control device and controlled by the control device to show a speech assistant image; and
a mobile device connected to the control device and installed with a mobile application program for getting the first speech text while the mobile application program having a translation module for translating the first speech text into a first translated text of the speech instantly.

13. The system as claimed in claim 12, wherein the speech assistance system further includes a camera connected to the control device; the camera is used for instantly taking an image of the speech and sending the image of the speech to the control device.

14. The system as claimed in claim 13, wherein the image of the speech includes the speech assistant image shown on the display device.

15. The system as claimed in claim 13, wherein the control device further includes an image recognition module that recognizes words in the image of the speech instantly to generate a third speech text.

16. The system as claimed in claim 13, wherein the mobile application program further includes an image recognition module that electrically connected to the translation module, the mobile device gets the image of the speech instantly, the image recognition module recognizes words in the image of the speech instantly to generate a third speech text, and the third speech text is translated to a third translated text of the speech instantly by the translation module of the mobile application program.

17. The system as claimed in claim 15, wherein the mobile device gets the third speech text instantly, and the translation module of the mobile device translate the third speech text into a third translated text of the speech instantly.

18. A speech assistance system in combination with at least one mobile device comprising:
a voice receiving device used for instantly receiving a speech;
a control device that is connected to the voice receiving device and used for receiving the speech in a real-time manner,
a display device connected to the control device and controlled by the control device to show a speech assistant image; and
a mobile device connected to the control device and installed with a mobile application program for getting the first translated text of the speech; the mobile application program having a speech recognition module that converts the speech into a first speech text instantly, and a translation module for translating the first speech text into a first translated text of the speech instantly.
